(19) United States
(12) Patent Application Publication
(10) Pub. No.: US 2005/0007305 A1
(43) Pub. Date: Jan. 13, 2005

(54) Multi color creation

(76) Inventors: Ib-Rune Johansen, Oslo (NO); Odd Lovhaugen, Olso (NO); Erik Wold, Oslo (NO)

Correspondence Address: ROTHWELL, FIGG, ERNST & MANBECK, P.C., 1425 K STREET, N.W., SUITE 800, WASHINGTON, DC, 20005, US

(21) Appl. No.: 10/647,112

(22) Filed: Aug. 25, 2003

(30) Foreign Application Priority Data
Jul. 11, 2003 (NO) 2003 3191

(51) Int. Cl. G09G 3/00

(52) U.S. Cl. 345/32

(57) ABSTRACT

This invention relates to a colour separator and the use of this in a projector, especially for video projectors, comprising a surface adapted to be moved through a light beam to be separated, the surface comprising a diffractive/holographic (DOE) optical element capable of directing different wavelengths comprised in the light beam toward different parts of a predetermined area. The diffractive optical element being essentially continues along one direction on the surface moved through the light beam and that direction of the separated colours depending on the position along the surface so as to provide a scanning of colours over each part of the predetermined area depending on the illuminated part of the diffractive surface

This invention relates to a device for providing colour separation and illumination, for example an imaging device of the micro mirror (DMD) or reflective liquid crystal on silicon (LCOS) types, from an essentially whitelight source.

At the present there is an increasing market for projectors of different types for projection of movies or computer generated presentation. Also, the increasing use of digital cameras generate an increasing demand for projectors capable of showing photographs with good quality.

The most common projector type has been based on liquid crystal devices for generating the image. This solution has the disadvantage of providing relatively low intensity images on the screen, as the LCD incorporates at least one polarisation filter which at the best absorbs more than half the light from the light source. In addition each pixel transmits at the best only 30% of the light, as it only transmits one of the primary colours. Thus a significant loss of light intensity is inherent to this type of projectors. LCOS from Philips is an example on a new kind of reflective LCD that now is available, and that is faster and better than transmission LCDs.

An alternative, but expensive, solution is based on the use of three separately controlled laser sources with different colours.

A third solution being increasingly popular in high quality projectors is based on micro mirror technology, e.g. the so-called DMD from Texas Instruments, being based on the projection of light toward a large number of small mirrors being adapted to reflect or not reflect light through the lens system toward the screen. The position of each mirror, along with the time each reflection lasts and the colour of the reflected light reconstruct the image on the screen. As this solution is based on reflection it has much better light intensity than the traditional LCD projectors.

Examples of the DMD projectors are described in U.S. Pat. Nos. 5,592,188, 5,467,146, 5,452,024 and 5,448,314, while solutions related to LCoS projectors are described in U.S. Pat. Nos. 6,023,309 and 6,053,165 as well as U.S. patent application Ser. No. 2002/0,159,033. These solutions have in common that they project light with different primary colours sequentially, which means that light from a white source is filtered before it is projected toward the reflective imaging device. Thus there is a loss of ⅔ of the generated light with a corresponding reduction in the luminosity of the projected image.

Usually the filtering is performed by a rotating colour wheel, as is described in U.S. Ser. Nos. 2002/0,176,055, 2002/0,135,862, WO 02/096123 and U.S. Ser. No. 2002/0,057,402, wherein the wheels may have the colour filters featuring a spiral shape so that the different colours scan over the reflective imaging device. As mentioned above this results in a loss of projected light intensity because only one colours is let through the filter at the time. In U.S. Ser. Nos. 2003/0,020,839 and 2001/0,008,470 a solution to this problem is proposed where the remaining light is reflected back into a rod in which it is blended with the light from the light source. The theory is that this should result in an increase in the amount of light sent to and thus through the filter. In practice this, however, has limited effect.

An alternative solution according to the known art is using rotating prisms, as shown in “Uniform color scrolling color LCoS projection” by Duncan J. Anderson, ms-2001-095_SPIEE_version, for separating the colours. This represents an expensive and complicated solution.

In U.S. patent application Ser. No. 2003/0,117,592 a solution is shown using a moveable array of holographic elements as filters. As in the abovementioned known art the holographic filters are used for extracting a chosen colour and projecting this at the imaging device. Thus also for this invention a maximum of only approximately ⅓ of the filtered light reaches the imaging device. Also, this solution illustrates the complexity of the optical system necessary to obtain the filtering.

It is thus an object of this invention to provide a colour separation device which increases the amount of light illuminating the imaging device. It is also an object of the invention to provide an improved projector by using diffractive optical elements for separating and controlling the light. This is obtained as is described in the independent claims.

This way a substantial improvement in the illumination system is provided as a larger part of the generated light is used to project an image through the projector. The solution according to the invention is also inexpensive and easy to produce, and omits the need for complicating parts such as the light blending rod used in U.S. Ser. Nos. 2003/0,020,839 and 2001/0,008,470.

The theory of the diffractive optical elements is described in WO 02/44673. As is evident from this specification the diffractive optical elements (DOEs) may provide a spectral image on a surface. It should be understood that the abreviation “DOE” here both refers to holographic and diffractive elements of the type mentioned in this international application.

If provided with a white light source, the whole visible spectrum may be projected at different parts on a chosen area. In this case the chosen area would be the imaging DMD or LCoS device. The DOEs described in WO 02/44673 are easily manufactured in large numbers as soon as they are produced, using the same technology as compact disc production, and being inexpensive for mass production. Other replication technologies may also be used, i.e. UV curable polymer on top of a substrate.

According to a preferred embodiment of the invention the DOE is positioned on a rotating part so as to provide a repeated scan of wavelengths over the predetermined area. The DOE may be positioned on a drum shaped surface or on a plane, disc shaped surface. In both cases the DOE is rotated so that the diffractive pattern, and thus the projected spectral pattern, repeats itself after being rotated 360 degrees. The pattern may of course also be repetitive after smaller sections of the circle, e.g. in each 90 degrees rotation.

According to another embodiment of the invention the separator is used in a video projector, said projector comprising a lamp with a chosen spectrum, focussing means for directing light toward a chosen part of the separator, imaging device positioned within said predetermined area and optical system for projecting the image.

According to another embodiment of the invention a video projector comprising colour separator is provided using the DOE element, also comprising a lamp with a chosen spectrum, focussing means for directing light toward a chosen part of the separator, imaging device positioned within said predetermined area, said imaging device being synchronised with said colour separator for providing an image corresponding to the colour projected on each part of the device, and an optical system for projecting the image.

According to yet another embodiment the DOE is provided with focussing means as described in WO 02/44673, which is incorporated here by way of reference, so as to remove the need for some of the optical systems related to the projector.

The invention will be better understood below with reference to the accompanying drawings, the drawings illustrating the invention by way of examples.

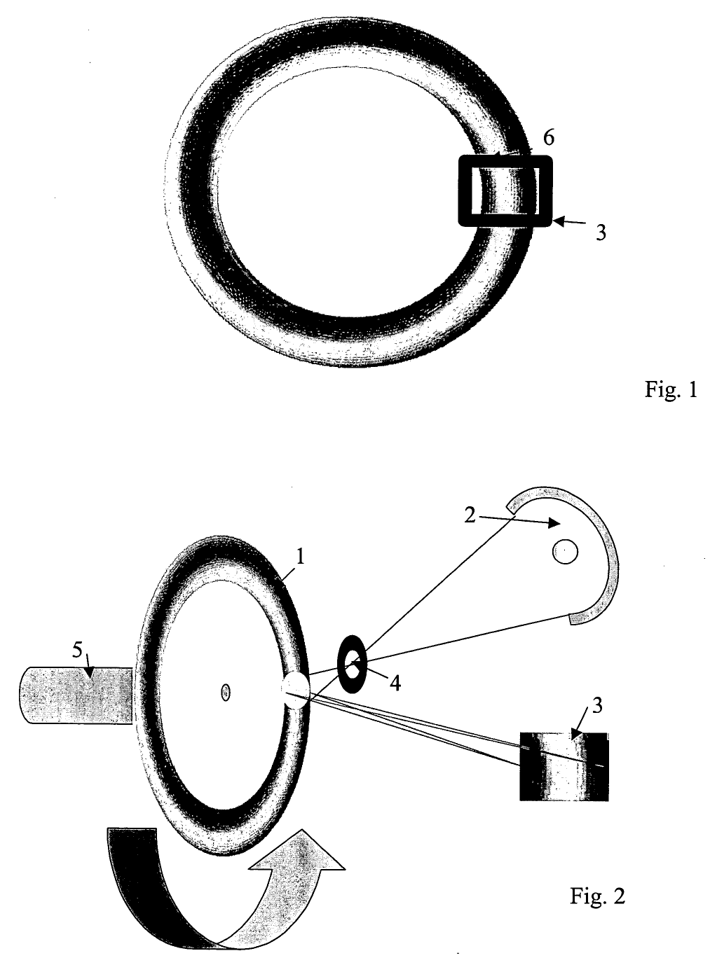

FIG. 1 illustrates one example of a colour pattern being moved over the imaging element.

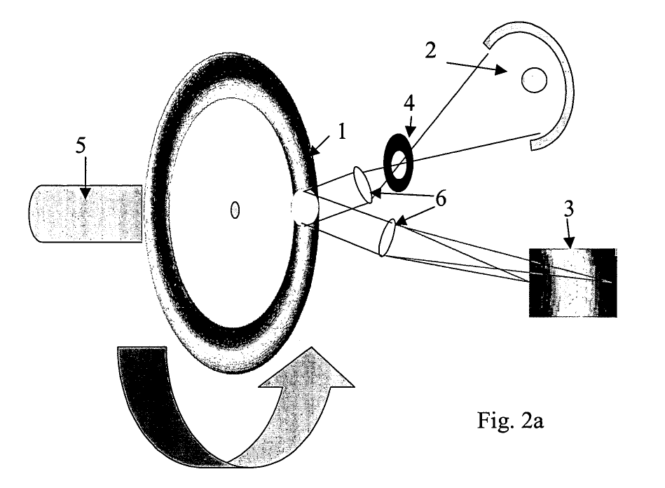

FIG. 2 illustrates a circular DOE being rotated according to a chosen axis, as well as the light source and imaging device.

FIG. 2a illustrates an alternative embodiment of the system illustrated in FIG. 2.

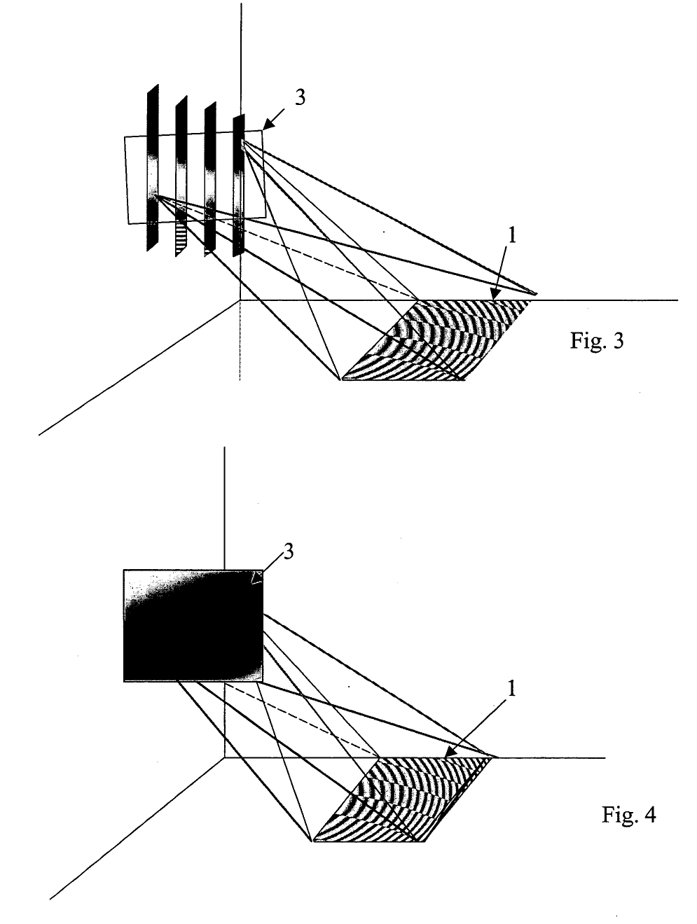

FIG. 3 illustrates the principle of a focussing DOE element

FIG. 4 illustrates a focussing DOE according to a preferred embodiment

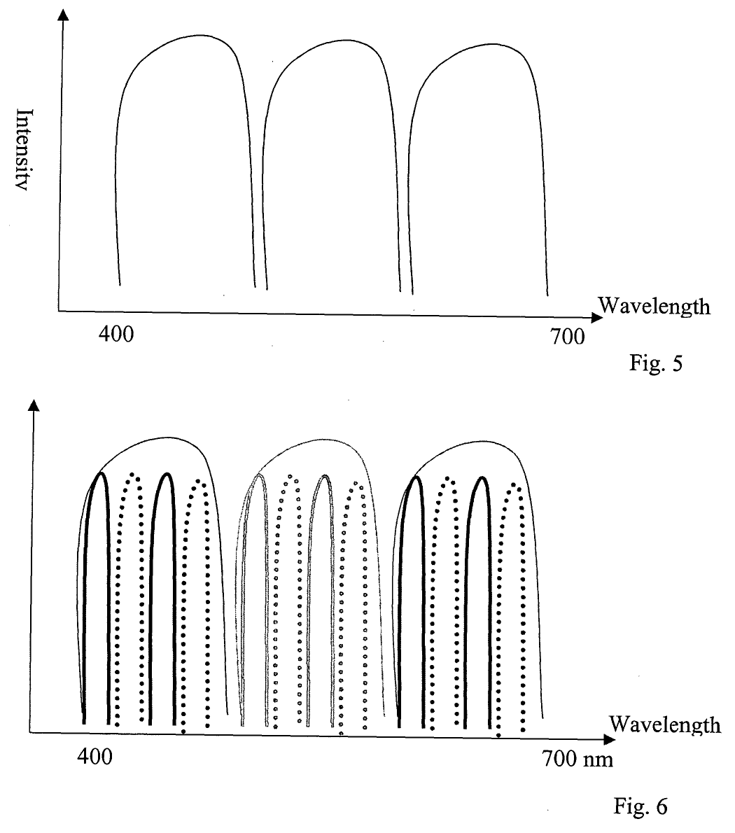

FIG. 5 illustrates the intensity spectrum of a traditional RGB colour spectrum

FIG. 6 illustrates an division of this for obtaining a 3D image separation with the device according to the invention

The colour pattern in FIG. 1 is rotated over the imaging device 6 (e.g. a DMD) so that the pattern of the spectrum shifts in a radial direction according to the ring. As the movements and characteristics of the DOE are known the wavelength of the light reaching each part of imaging device is known. Thus the imaging device may be made to provide a reflection or non-reflection at the present colour.

This provides an advantage over the known art as the imaging device may reflect any chosen colour in the available spectrum, thus to expand the available colour space in the image relative to the conventional RGB based colours. Separating the spectrum into more than 3 primary colours it is thus possible to obtain high quality image projections incorporating colours and colour intensities that are not available in the RGB colour space. In this case it is also possible to provide the DOE with a part reflecting white light, so as to increase the available contrast in projected images. Also, the transition between the colours is omitted, so that the active period of the imaging device may be extended.

The control devices used for controlling the imaging devices obtaining this may be based on standard electronics and will not be described in any detail here. It may, however, be provided with monitoring detectors for detecting the colours at selected points and thus synchronising the rotation of the DOE relative to the imaging device. Alternatively one or more DOE patterns may be provided to split one or more wavelengths and sent parts of this to one or more monitoring detectors coupled to the imaging device.

In FIG. 2 a simplified view of the colour separation system is shown. A light source 2 with a known emission spectrum is provided for directing light toward the rotating DOE through an aperture 4. The DOE 1 diffracts light toward the imaging device 3, the light being separated into a rainbow pattern. As the DOE rotates different parts of it is illuminated by the light source. The DOE is adapted to project different colour patterns depending on the position along the surface. Preferably the colours shift continuously over the imaging device as the DOE rotates e.g. so that the red band moves over the imaging device as the DOE rotates, and when it reaches the edge a new red band appears at the opposite edge of the imaging device. In practice this may be accomplished by programming the DOE during production to e.g. have overlapping first and second order diffraction patterns.

As mentioned above the colour pattern on the imaging device repeats itself when the DOE disc or drum has rotated 360 degrees. For production purposes it may, however, be advantageous to let the pattern repeat itself over a shorter segment, e.g. 90 degrees.

For implementation in real projectors reference is made to the cited documents, which describes solutions which with some adaptations may implement the present invention, possibly with the omission of some optical elements because of the provided focussing and beam shaping capabilities of the DOEs. The principle of the invention as illustrated in FIG. 2 is, however, possible according to a preferred embodiment of the invention, as the DOE may be adapted to focus the spectrum toward the imaging device.

FIG. 2a shows an alternative comprising some traditional optical elements 6 in addition to the DOE 1. As mentioned above the DOE may have other shapes than the flat ringshaped structure shown here. It may be positioned on a drum, or it may even be constituted by a plane DOE being tiltet or rotated relative to an axis in the DOE plane, depending on the use and techincal requirements present in the specific situation. The main aspect being that the DOE provides a repeating spectral illumination of the imaging device.

In that case the DOE may comprise a discontinuous diffracting pattern including a large number of small DOEs, e.g. as illustrated in the abovementioned WO 02/44673 and in FIGS. 3 and 4. The DOEs are manufactured through custom design of synthetic surface holograms, and may thus be programmed to provide a chosen colour separation and focussing capability. As it may be mass produced using CD-molding equipment it is possible to produce it in large quanta at a cost of approximately 1$ each.

In FIG. 3 a DOE is shown which a number of different colour spectra toward an imaging device 3. When scanning through a number of different DOEs, e.g. on a ring or drum according to the invention, the spectra may be shifted in position of in colour distribution so as to change the spectra received at the imaging device.

In FIG. 4 the DOE is programmed to transmit a colour spectrum covering the whole imaging device. If the DOE ring according to this invention comprises a continuous sequence of DOEs as illustrated in FIG. 4 a continuous og semi-continuous shift in the spectrum projected at the imaging device may be obtained. By synchronising the imaging device with the spectrum from the DOE the imaging device may reflect the correct colour at the right time, thus making it possible to generate images in any required colour.

Also, if the exact spectrum of the light source is known, the DOE or the imaging device may be programmed to take the lamps inherent colour and intensity deviations into account.

According to another embodiment of the invention a single projector 3D colour projection may be obtained using the fact that the whole colour spectrum is produced and not only wide filter bands. Thus two overlapping images may be projected simultaneously, colour coded in separate e.g. red, green and blue wavelength bands. 3D perception is obtained by observing the projected image through corresponding filters in front of left and right eyes. Such filters may be realized as e.g. fabry-perot filters. Compared to polarisation based solutions, this embodiment requires only a normal diffuse screen.

FIG. 5 illustrates a standard RGB spectrum comprising fairly broad banded wavelength ranges representing each colour. FIG. 6 illustrates how the capability of this invention to differentiate between wavelengths, and thus the expanded colour space, may be used to two sets of images which by a viewer both will appear as full colour RGB images. If the viewer is provided with a correct set of filters, e.g. Fabry-Perot filters, being capable of letting through light within limited, chosen ranges of wavelengths, the view may be able to see only one of the projected images. If the viewer is provided two different filters, one for each eye, the eyes will be able to see two different images. In FIG. 6 the dotted lines represent the wavelengths seen by the left eye and the continuous represents the right eye. The left eye sees an image compound by RGB, but at a slightly different wavelength than the right eye. A Fabry-Perot filter selects the two different images, one for the left eye and a complimentary filter for the right eye. Colours may be corrected by signal processing and RGB calibration as in present systems

Thus it will be possible to project stereoscopic images by simultaneously projecting two images at slightly different sets of wavelengths. The only loss of quality is in projected lumens as the colour space sensed by with eyes are within the standard RGB colour space. In fact, in the shown example the projection still allows for 6 primary colours at each eye, thus still representing an improvement over standard projectors.

This 3D image projector hasia lot of advantages over the known art, as it only requires one projector with a standard diffuse screen, and not a polarisation preserving screen as is required e.g. by polarisation based 3D projectors such as IMAX.

1. Colour separator, e.g. for video projectors, comprising a surface adapted to be moved through a light beam including a number of wavelengths to be separated, the surface comprising a diffractive or holographic optical element (DOE) capable of directing different wavelengths comprised in the light beam towards different parts of a predetermined area said diffractive/holographic optical element generating a repeating colour
pattern, e.g. a continuos colour spectrum, as a function of scanning.

2. Separator according to claim 1, wherein the surface is positioned on a rotating part so as to provided a repeated scan of wavelengths over the predetermined area.

3. Separator according to claim 1, wherein the surface is drum shaped being rotatable according to the drum axis.

4. Separator according to claim 1, wherein the surface is a plane, disc shaped surface.

5. Separator according to claim 1, wherein the DOE is constituted by a number of focussing DOEs, each for directing the separated colours to selected parts of the imaging device.

6. Separator according to claim 5, wherein the focussing are at least partially overlapping.

7. Separator according to claim 1, wherein the DOE is adapted to direct both first and second order diffraction toward the imaging device, and that the DOE is provided with a smooth transition between the two when moved along the direction of movement.

8. Separator according to claim 1, wherein the DOEs are reflective.

9. Separator according to claim 1, wherein the DOEs are transparent diffracting the light passing through the elements.

10. Separator according to claim 1, wherein the DOE is constituted by a thick film holographic element.

11. Separator according to claim 1, wherein the DOE is constituted by a surface hologram.

12. Separator according to claim 1, wherein the DOE is provided on a flat surface being tilted or rotated relative to a chosen axis for scanning through the diffracted spectrum.

13. Use of colour separator according to claim 1, in a video projector, said projector comprising a lamp with a chosen spectrum, focussing means for directing light toward a chosen part of the separator, imaging device positioned within said predetermined area and optical system for projecting the image.

14. Video projector comprising colours separator according to claim 1, also comprising a lamp with a chosen spectrum, focussing means for directing light toward a chosen part of the separator, imaging device positioned within said predetermined area, said imaging device being synchronised with said colour separator for providing an image corresponding to the colour projected on each part of the device, and an optical system for projecting the image.

15. Use of a video projector according to claim 14 for projecting stereoscopic images, wherein the imaging device is programmed to project two images at different sets of wavelengths, representing stereoscopic images, said sets of wavelengths both corresponding to a full RGB colour spectrum, said images being viewable using two adapted filtering devices, each letting one of said sets of wavelengths through.
